(19) United States
(12) Patent Application Publication
(10) Pub. No.: US 2020/0243113 A1
(43) Pub. Date: Jul. 30, 2020

(54) Vehicle Camera and Record System

(71) Applicants: Alice Wilson Roberson, Parmelee, NC (US); Roosevelt Mckinley Roberson, Parmelee, NC (US); Jermal Dirailli Roberson, Matthews, NC (US)

(72) Inventors: Alice Wilson Roberson, Parmelee, NC (US); Roosevelt Mckinley Roberson, Parmelee, NC (US); Jermal Dirailli Roberson, Matthews, NC (US)

(21) Appl. No.: 16/719,205

(22) Filed: Dec. 18, 2019

Related U.S. Application Data
(60) Provisional application No. 62/798,545, filed on Jan. 30, 2019.

(51) Int. Cl. G11B 20/10; H04N 5/247

(52) U.S. Cl. CPC G11B 20/10527; G11B 2020/10851; G11B 2020/10592; H04N 5/247

(57) ABSTRACT

A vehicle camera and record system including a plurality of cameras located around a vehicle. The cameras are positioned such that at least a 360-degree planar view is provide surrounding the vehicle. A control unit is operably coupled to the cameras. The controller includes a computer readable storage device. The cameras will record the surrounding area of the vehicle. Media recorded by the cameras will be stored on the computer readable storage device such that the media can be accessed at a later time and date.

### CROSS REFERENCE TO RELATED APPLICATIONS

This application claims the benefit of U.S. Provisional Application No. 62/798,545 filed on Jan. 30, 2019. The above identified patent application is herein incorporated by reference in its entirety to provide continuity of disclosure.

### BACKGROUND OF THE INVENTION

The present invention relates to vehicle cameras. More particularly, the present invention provides a vehicle camera system that will be able to keep records of accidents and, in a commercial setting keep track of the logs for the driver.

Accidents frequently happen in motor vehicles. Once these accidents happen, it can be difficult to determine what actually happened. When an individual suffers a traumatic event, it can be difficult to remember the details let alone factually recount what happened. This can be extremely problematic when a car accident occurs.

Many times, the person at fault for the accident must cover the cost of the damage. Even with insurance, this will cost the individual a considerable amount of money. This could lead some people to claim they were not at fault even when they were. This can be an especially large issue for commercial drivers, such as delivery drivers or semi drivers. While it may be true that the company will cover the insurance when one of these professionals is in an accident the individual could face various forms of discipline at work, including being fired.

Further, in some instances, vehicles are stolen either for a joyride or to be chopped up and sold. In these instances, it can be very difficult to locate the vehicle. In many cases, even if the vehicle is located, the thief may never be caught. While some cars do provide GPS or a single camera, these cameras are not positioned to capture the entire area surrounding a vehicle. Further, many times there is a monthly charge to monitor the whereabouts of a vehicle.

Consequently there is a need in for an improvement in the art of vehicle cameras. The present invention substantially diverges in design elements from the known art while at the same time solves a problem many people face when attempting to record the real time action of a car accident. In this regard the present invention substantially fulfills these needs.

### SUMMARY OF THE INVENTION

The present invention provides a vehicle camera and record system wherein the same can be utilized for providing convenience for the user when using a video system for a vehicle. The vehicle camera and record system is comprised of a plurality of cameras positioned around a vehicle. The plurality of cameras are operably coupled to a control unit. The control unit turns the cameras on and off and directs storage of the captured video. There is a computer readable storage device operably coupled to control unit to store the video footage.

Another object of the vehicle camera and record system is for the cameras to be removably attached to the vehicle.

Another object of the vehicle camera and record system is to provide cameras that are wirelessly coupled to the control unit.

Another object of the vehicle camera and record system is to have a power source located in each camera.

Another object of the vehicle camera and record system is to have the cameras are wired to the control unit.

Another object of the vehicle camera and record system is to have a sensor located within the door handle of a vehicle, wherein the sensor is operably coupled to the control unit. The sensor will detect an attempted entry into the vehicle and start the recording of the cameras.

Another object of the vehicle camera and record system is to have a sensor that detects when the vehicle is in use, wherein the sensor is operably coupled to the control unit.

Another object of the vehicle camera and record system is to have the control unit is located within the dash.

Another object of the vehicle camera and record system is to have a display screen operably coupled to the control unit.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the cameras attached to a vehicle.

FIG. 2 shows a perspective view of an embodiment of the cameras attached to a semi.

FIG. 3 shows a perspective view of an embodiment of the controller installed within a dashboard of a vehicle.

FIG. 4 shows a wiring diagram of an embodiment of the vehicle camera and record system.

FIG. 5 shows a flow chart of an embodiment of a method for operating the vehicle camera and control system.

### DETAILED DESCRIPTION OF THE INVENTION

Reference is made herein to the attached drawings. Like reference numerals are used throughout the drawings to depict like or similar elements of the vehicle camera and record system. For the purposes of presenting a brief and clear description of the present invention, a preferred embodiment will be discussed as used for the vehicle camera and record system. The figures are intended for representative purposes only and should not be considered to be limiting in any respect.

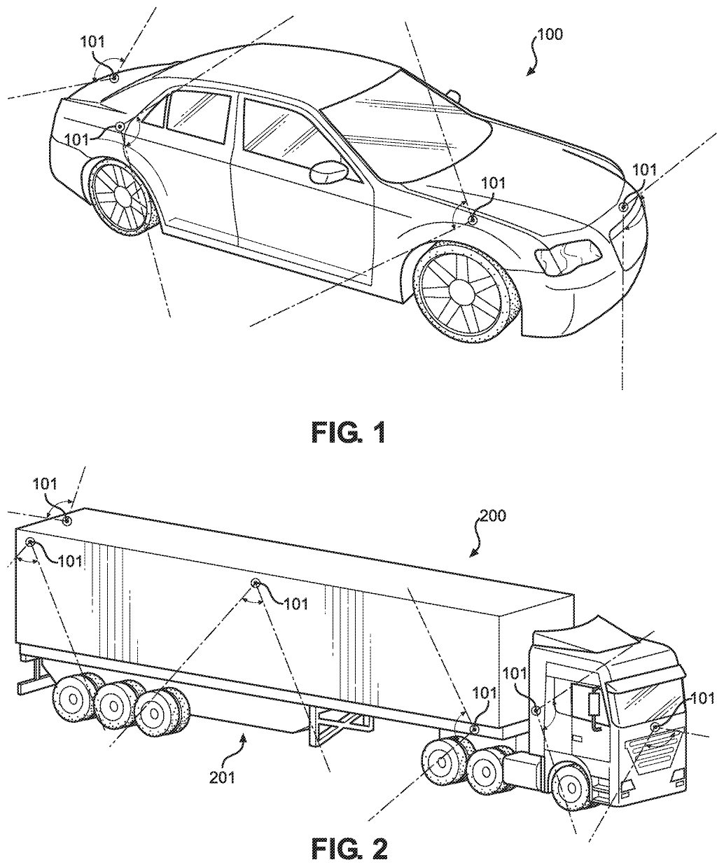

Referring now to FIG. 1, there is shown a perspective view of an embodiment of the cameras attached to a vehicle. The vehicle camera and record system 100 is designed to work with a plurality of cameras 101. In one embodiment, each camera of the plurality of cameras 101 is a waterproof camera. In one embodiment, the plurality of cameras 101 are magnetically attached to the vehicle. In this embodiment, there is a magnet located on the base of each camera. In another embodiment, the plurality of cameras 101 are fixed to the vehicle.

The plurality of cameras 101 are capable of recording video or taking images. The plurality of cameras 101 may have a variety of angles of capture. In one embodiment, the angles are different for each camera respectively. At least one camera is placed on a vehicle such that it can record the surroundings of the vehicle. There can be a plurality of cameras 101 placed at various places on the vehicle to be able to record a 360-degree area around the vehicle. In one embodiment, a camera is located under the vehicle. This camera will be able to capture the parts under the vehicle and take notice if a part breaks. This will allow a user to diagnose an issue earlier or stop and pull over if a dangerous situation occurs due to a part breaking.

Referring now to FIG. 1 and FIG. 2, there is shown a perspective view of an embodiment of the cameras attached to a car and semi respectively. The plurality of cameras 101 are placed in various locations around different vehicles. In one embodiment, there are cameras placed on the hood and trunk of a car as well as above each wheel. In this embodiment, the camera angles will capture the front and rear of the vehicle and the doors. The plurality of cameras 101 may capture different fields of vision to ensure that the video will capture the entire surrounding of the vehicle. Further, in another embodiment cameras are placed around a semi-truck and trailer. In one embodiment the cameras are placed on the front, rear, top, and side of the trailer as well as the front and sides of the truck. In one embodiment the cameras have a slightly overlapping field of view. In another embodiment the cameras are positioned such that when viewed together they give a full panoramic view.

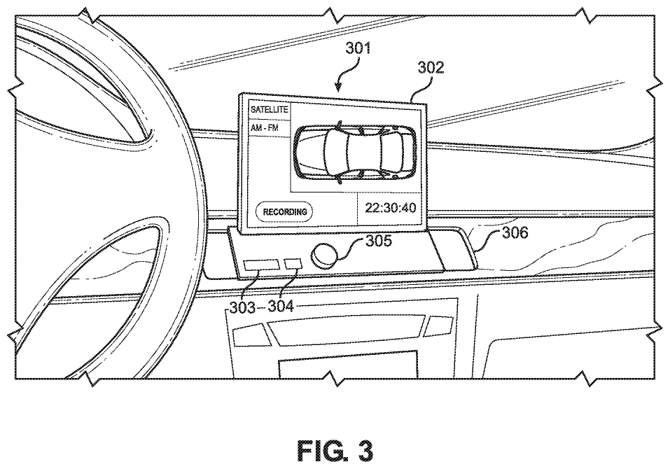

Referring now to FIG. 3, there is shown a perspective view of an embodiment of the control unit installed within a dashboard of a vehicle. The cameras surrounding the outside of the vehicle are operably coupled to a control unit 301 located on the interior of the vehicle. In one embodiment, the controller 301 is built into the dashboard 306. In an embodiment where the control unit 301 is in the dashboard 306, the controller 301 also functions as the vehicle's audio head unit. This will allow the control unit 301 to take the place of a standard head unit and not require a special dashboard cutout in order to be installed. In another embodiment, the control unit 301 can be placed on the top of the dashboard 306. This will allow for an easy install.

The control unit 301 has several ports 303, 304 located on a front thereof. In one embodiment, a first port 303 is a memory card slot. In one embodiment, the first port 303 is configured to accept micro SD cards. In another embodiment, the first port 303 is configured to accept SD cards. The first port 303 will allow for additional storage to be added to the control unit 301. In another embodiment, the first port 303 will allow an individual to insert a card and take information from the controller 301. The control unit 301 further has a second port 304. In one embodiment, the second port 304 is configured to accept a USB connector. In another embodiment, the second port 304 is configured to accept micro USB connectors. In this way, the second port 304 will allow a user to attach a computer or other device to the controller 301.

The control unit 301 further has a display screen 302 attached thereto. The display screen 302 will allow a user to view the video recorded by the cameras. In one embodiment, the display screen 302 is an LCD screen. In one embodiment, the display screen 302 is in a fixed position. In another embodiment, the display screen 302 is capable of folding down and sliding within the housing of the control unit 301. In this embodiment there is a slot located within the housing of the control unit 301 that is dimensioned to receive the screen therein. Further, the screen is pivotally secured to a sliding track located within the slot. This will allow the screen to be tilted down then pushed into the housing. In one embodiment, the display screen 302 is a touch screen. The display screen 302 will be capable of having a picture in picture feature. This will allow a person to view the video and do another task at the same time.

In one embodiment the display screen 302 is further configured to display a designation if a door is opened. In another embodiment the control unit 301 will direct the display screen to show commercial drivers daily logging. In another embodiment the system will have an alarm clock functionality. In one embodiment the cameras can be accessed as a back-up camera system. In one embodiment the control unit is further configured to have a radio build therein. This radio can pick up AM and FM. In one embodiment the radio is further configured to play satellite radio.

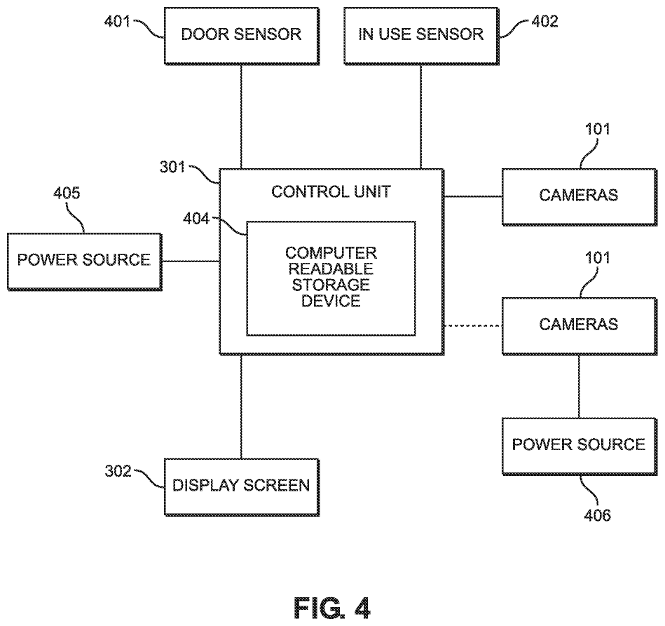

Referring now to FIG. 4, there is shown a wiring diagram of an embodiment of the vehicle camera and record system. The control unit 301 is located within the controller as described in FIG. 3. The control unit 301 will control the operation of the cameras 101. Further, the control unit 301 will manage the saving of the video recorded by the cameras 101. The control unit 301 is operably coupled to a computer readable storage device 404. In one embodiment, the computer readable storage device 404 is located within the central control unit 301. The control unit 301 is operably coupled to the display screen 302.

The control unit 301 is electrically connected to a power source 405. In one embodiment the power source 405 is a vehicle battery. The central controller 403 will then send power to the rest of the system respectively. In one embodiment the central controller 403 is operably coupled to a door sensor 401. In one embodiment the door sensor 401 is located within the door handle. In another embodiment the door sensor 401 is located within the door. In another embodiment the control unit 301 is operably coupled to an in-use sensor 402. The in-use sensor 402 will allow the central controller 403 to determine if the vehicle is in use. In one embodiment the control unit 3031 is operably coupled to both the door sensor 401 and the in-use sensor 402.

The control unit 301 is operably coupled to at least one camera 101. In one embodiment the cameras 101 are connected to the control unit 301 via a wired connection. In this embodiment the cameras 101 are wired into the central controller 403 through the vehicle. In another embodiment the cameras 101 are wirelessly connected to the control unit 301. In this embodiment the camera 101 is coupled to a different power source 406. This will allow the camera 101 to be separable from the vehicle. In these embodiments the control unit 301 further has a wireless transceiver. The wireless transceiver can be configured to transmit and receive in various different forms.

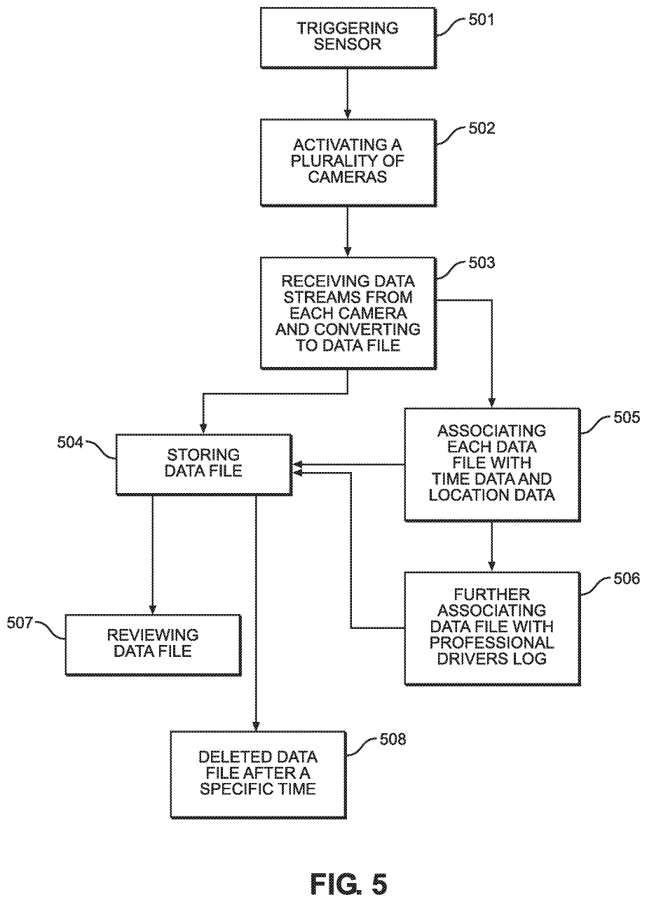

Referring now to FIG. 5, there is shown a flow chart of an embodiment of a method for operating the vehicle camera and control system. In one embodiment the method starts when a sensor is triggered 501. The sensor will signal to the control unit to activate the plurality of cameras 502. The controller will then receive streams from each of the plurality of cameras 503. Next the controller will direct the data streams to be saved as data files. In another embodiment, the control unit will associate the data files with further data 505. In one embodiment the further data comprises, a date, a time, a location stamp. From this stage, the data files can then be stored 504. In another embodiment, the data files will further be associated with a professional driver log 506. After the data is properly associated the data is then stored 504. After the data is stored the data can be reviewed 507 in one embodiment. In another embodiment the data can be automatically deleted if not used after a specified amount of time 508.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A vehicle camera and record system, comprising:
a plurality of cameras positioned around a vehicle;
wherein the plurality of cameras are operably coupled to a control unit;
wherein the control unit turns the cameras on and off and directs storage of video footage captured by the plurality of cameras;
a computer readable storage device is operably coupled the control unit to store the video footage.

2) The vehicle camera and record system of claim 1, wherein the plurality of cameras are removably attached to the vehicle.

3) The vehicle camera and record system of claim 1, wherein the plurality of cameras are wirelessly coupled to the control unit.

4) The vehicle camera and record system of claim 1, further comprising a power source located in each camera of the plurality of cameras.

5) The vehicle camera and record system of claim 1, wherein the plurality of cameras are wired to the control unit.

6) The vehicle camera and record system of claim 1, further comprising a sensor located within a door handle of the vehicle wherein the door sensor is operably coupled to the control unit;
the sensor will detect if someone attempts to enter the vehicle and begin the recording process.

7) The vehicle camera and record system of claim 1, further comprising an in use sensor that detects when the vehicle is in use, wherein the sensor is operably coupled to the control unit.

8) The vehicle camera and record system of claim 1, wherein the control unit is located within the dash.

9) The vehicle camera and record system of claim 8, further comprising a display screen operably coupled to the control unit.

10) A method for controlling a plurality of vehicle cameras, the method comprising:
activating a plurality of cameras;
receiving a data stream from each of the plurality of cameras;
storing the data stream from each camera as a data file.

11) The method for controlling a plurality of vehicle cameras of claim 10, the method further comprising: storing each data stream with at least time, date, and location data attached to the data file.

12) The method for controlling a plurality of vehicle cameras of claim 10, further comprising activating the cameras upon an event trigger.

13) The method for controlling a plurality of vehicle cameras of claim 12, wherein the event trigger is an attempted entry into the vehicle.

14) The method for controlling a plurality of vehicle cameras of claim 12, wherein the event trigger is the vehicle being driven.

15) The method for controlling a plurality of vehicle cameras of claim 10, storing the data files in correlation with a professional driver's daily logs.

16) The method for controlling a plurality of vehicle cameras of claim 10, further comprising deleting data files that are older than a specified amount of time.

17) The method for controlling a plurality of vehicle cameras of claim 10, displaying play back of the stored data files.
